(19) United States
(12) Patent Application Publication
(10) Pub. No.: US 2019/0295414 A1
(43) Pub. Date: Sep. 26, 2019

(54) SYSTEM AND METHOD FOR IDENTIFICATION OF LOCATION TYPES OF PASSENGERS

(71) Applicant: ANI TECHNOLOGIES PRIVATE LIMITED, Bengaluru (IN)

(72) Inventors: Rajesh Kumar Singh, Bokaro Steel City (IN); Ankit Modi, Bangalore (IN); Harshit Sharma, Delhi (IN)

(73) Assignee: ANI Technologies Private Limited

(21) Appl. No.: 16/124,942

(22) Filed: Sep. 7, 2018

(30) Foreign Application Priority Data
Mar. 21, 2018 (IN) 201841010470

(51) Int. Cl. G08G 1/123; G08G 1/01; G06Q 30/02; G06Q 50/30

(52) U.S. Cl. CPC G08G 1/123; G06Q 50/30; G06Q 30/0205; G08G 1/0129

(57) ABSTRACT

A method and a system for identifying location types of each passenger are provided. Location information associated with historical booking and demand data of passengers is clustered to obtain a set of location clusters. A set of features is generated for each location cluster, and a classifier is trained based on the generated set of features. Location information of a passenger is received from a passenger device of the passenger. The trained classifier identifies a location type of the passenger based on the location information. The identified location type can be used for providing personalized experience to the passenger.

### CROSS-RELATED APPLICATIONS

This application claims priority of Indian Application Serial No. 201841010470, filed Mar. 21, 2018, the contents of which are incorporated herein by reference.

### FIELD OF THE INVENTION

The present invention relates generally to location identification systems, and more particularly, to a method and a system for identifying types of locations of passengers based on travel patterns of the passengers.

### BACKGROUND

Public transportation systems generally include multiple vehicles that are used by a large number of travelers. To aid efficient management and planning of transportation systems, it would be desirable to identify different location types within a geographical area in which travel patterns of the travelers originating or ending their journeys are similar. By identifying these location types, administrators would be able to build and maintain more efficient transportation systems while providing vehicle services to the travelers at the right times and locations. For example, as a majority of the travelers leave from their home locations to their work locations between 8 AM and 10 AM during weekdays, the administrators may increase the number of vehicles that can operate between 8 AM and 10 AM from ‘home’ locations of the passengers.

To quantify passenger travel, source-destination matrices have been developed in the past. A source-destination matrix for each passenger includes pick-up locations, corresponding drop-off locations, and corresponding pick-up times. Thus, the source-destination matrix represents the spatial and temporal distribution of travels between different pick-up and drop-off locations in a transportation network such that the spatial distribution indicates the travel patterns of each passenger across different locations and the temporal distribution indicates the travel patterns of each passenger across different timelines, for example, over a day, a week, a month, or the like. Such source-destination matrices have been used to forecast the future demands for the transportation systems. Conventionally, the source-destination matrices were obtained manually, for example, using household surveys and roadside interviews of different individuals. More recently, such source-destination matrices are being obtained automatically by processing historical travel patterns of the travelers based on, for example, the global positioning system (GPS) information obtained from smartphones carried by the travelers during their travels or on-board GPS systems of the vehicles that the passengers travel in.

The limited information acquired through manual surveys and interviews can be made comprehensible for experts, according to predefined location types from where the individuals may want to travel to different locations. However, such manual surveys and interviews are time consuming and may be insufficient to determine the travel patterns from the predefined location types. The determination of the source-destination matrices based on automatically collected travel data may be less time consuming, however, it is not readily comprehensible to human reviewers, particularly when massive and detailed travel data permits different levels of granularity, with fine-grained source-destination matrices, often for different days of the week or different time-frames. Thus, the automatic ways of obtaining the source-destination matrices for determining the location types of each passenger may not be trusted due to lack of a quality check of the source-destination matrices at different points of times during a day, a week, a month, or the like.

In light of the foregoing, there exists a need for a technical and more reliable solution that solves the above-mentioned problems and identifies location types of passengers in a way that may allow the transportation systems to provide personalized experiences to the passengers, for example, ensuring availability of vehicles at or near the identified locations, thereby, improving booking and travel experiences of the passengers.

### SUMMARY

In an embodiment of the present invention, a method and a system for identifying location types of each passenger in a transportation network are provided. The method includes one or more operations that are executed by circuitry of the system to identify the location types of each passenger. The circuitry extracts historical booking and demand data of passengers from a database server over a communication network. The location information associated with the extracted historical booking and demand data is clustered to obtain a set of location clusters. The location information may be clustered by means of a density-based clustering algorithm to obtain the set of location clusters. For each location cluster, the circuitry generates a set of features based on the extracted historical booking and demand data of each location cluster.

The set of features includes a set of travel-time-based features and a set of location-type-based features. The set of travel-time-based features includes demand-based features and booking-based features. The demand-based features include one or more features such as a first weekday demand feature associated with a first time duration, a second weekday demand feature associated with a second time duration, a third weekday demand feature associated with a third time duration, a fourth weekday demand feature associated with a fourth time duration, and a weekend demand feature. The first, second, third, and fourth time durations of each weekday are different from each other. The booking-based features includes a first weekday pick-up or drop-off feature associated with the first time duration, a second weekday pick-up or drop-off feature associated with the second time duration, a third weekday pick-up or drop-off feature associated with the third time duration, a fourth weekday pick-up or drop-off feature associated with the fourth time duration, and a weekend pick-up or drop-off feature. Further, the set of location-type-based features includes the demand-based features and the booking-based features of the set of travel-time-based features. The set of location-type-based features further includes an average stay time of each passenger in a location and a percentage of return demand from the location by each passenger.

Further, the circuitry trains a classifier based on the generated set of features to identify a type of each location cluster. The set of travel-time-based features and the set of location-type-based features are combined to generate a tree-based model for classifying the location information of each passenger. The circuitry further receives location information of a passenger from a passenger device of the passenger over the communication network. The circuitry generates a set of features based on pick-up or drop-off locations associated with the received location information of the passenger. The generated set of features is provided as an input to the trained classifier. The trained classifier identifies a location type of the location information. The location type may be at least one of a home location, a work location, a commercial location, a transit location, or an unknown location.

Thus, the method and the system of the present invention provide a choice to identify the location type of each passenger. Based on the identified location types of each passenger, future needs of the passenger such as booking of vehicles for rides may be identified. For example, based on an identified location type of a passenger from where the passenger may take a vehicle for a ride (e.g., home to office, home to shopping, or the like), personalized experiences may be provided to the passenger inside the vehicle during the ride. Thus, the method and the system of the present invention allow a vehicle service provider, for example, a cab service provider, to identify the preferences of the passengers for the various locations, ensure availability of the vehicles to the passengers from the identified locations, and provide personalized experiences during the rides with the vehicles.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates an environment in which various embodiments of the present invention are practiced;

FIGS. 2A and 2B, collectively, is an exemplary sequence diagram for classifying location information of a passenger by means of a tree-based model, in accordance with an embodiment of the present invention;

FIG. 3 is a flow chart that illustrates a method for identifying location types of passengers, in accordance with an embodiment of the present invention; and

FIG. 4 is a block diagram that illustrates a computer system for identifying location types of passenger, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes systems and methods for identifying location types of passengers for providing personalized experience to the passengers during their rides. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

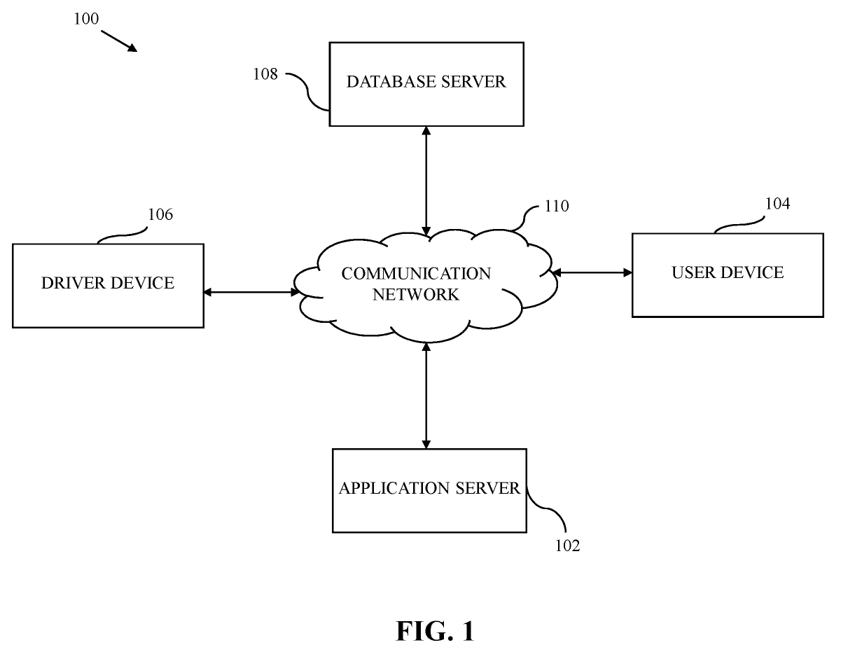

Referring now to FIG. 1, a block diagram that illustrates an environment 100 in which various embodiments of the present invention are practiced, is shown. The environment 100 includes an application server 102, a passenger device 104, a driver device 106, and a database server 108 that communicate with each other by way of a communication network 110. Examples of the communication network 110 include, but are not limited to, a wireless fidelity (Wi-Fi) network, a light fidelity (Li-Fi) network, a satellite network, the Internet, a mobile network such as a cellular data network, a high-speed packet access (HSPA) network, or any combination thereof.

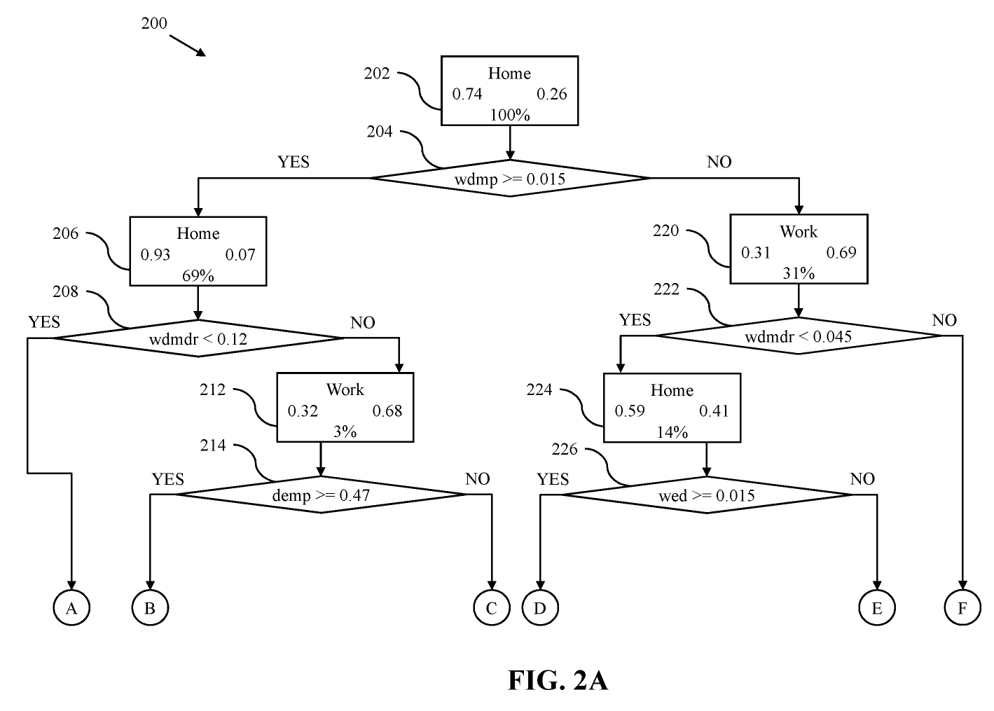

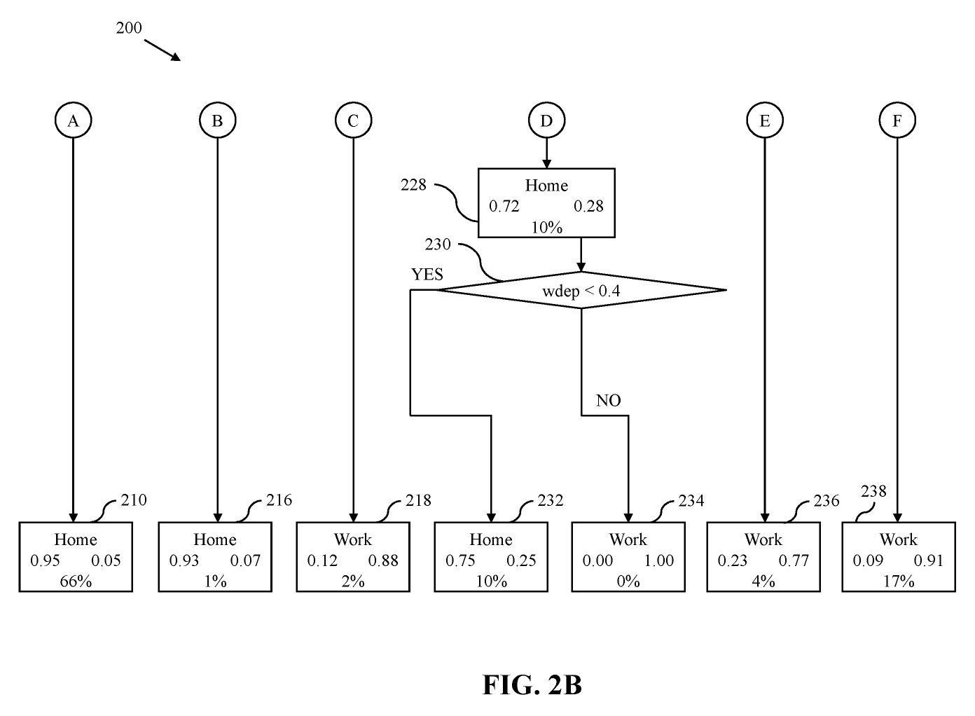

The application server 102 is a computing device, a software framework, or a combination thereof, that may provide a generalized approach to create the application server implementation. In an embodiment, the operation of the application server 102 may be dedicated to execution of procedures, such as, but not limited to, programs, routines, or scripts stored in a memory for supporting its applied applications. In an embodiment, the application server 102 generates a set of features for each location cluster based on historical booking and demand data of each location cluster including that of passengers, and thereafter, trains a classifier based on the generated set of features to identify a location type of each location cluster. The trained classifier identifies the location type of location information associated with a passenger. The location type may be one of a home location, a work location, a commercial location, a transit location, an unknown location, or the like. Various operations of the application server 102 have been described below in detail, and further in conjunction with FIGS. 2A, 2B, 3, and 4. Examples of the application server 102 include, but are not limited to, a personal computer, a laptop, or a network of computer systems. The application server 102 may be realized through various web-based technologies such as, but not limited to, a Java web-framework, a .NET framework, a PHP framework, or any other web-application framework.

The passenger device 104 is a computing device that is used by the passenger to perform one or more activities, including transmitting a booking request by means of a service application installed on the passenger device 104 to the application server 102. The booking request may be a request for a ride to travel between various locations including pick-up and drop-off locations. To schedule the ride, the passenger uses the passenger device 104 to initiate the booking request, and provides details of the booking request, such as a pick-up location, a drop-off location, a vehicle type, a pick-up time, or the like, by means of the installed service application. In response to the transmitted booking request, the passenger device 104 receives allocation information for the requested ride from the application server 102. The passenger views the allocation information on the passenger device 104 by means of the installed service application, and provides an input, either to confirm or reject allocation by the application server 102. Examples of the passenger device 104 include, but are not limited to, a personal computer, a laptop, a smartphone, a tablet computer, and the like.

The driver device 106 is a computing device that is used by a driver of a vehicle to perform one or more activities, including viewing a new booking request. The driver uses the driver device 106 to accept or reject the new booking request, to view passenger information of the passenger based on allocation of the vehicle to the passenger by the application server 102, to view a route between the pick-up and drop-off locations, or the like. The driver device 106 transmits real-time booking status and real-time position information of the vehicle to the application server 102 over the communication network 110. The real-time booking status may indicate whether the vehicle is currently occupied with an ongoing ride/booking request or is available for the new booking request. The real-time position information may indicate current position information of the vehicle. The current position information of the vehicle may be determined based on global positioning system (GPS) information detected by one or more position-tracking sensors associated with the driver device 106. In another embodiment, the one or more position-tracking sensors may be separately embedded in the vehicle of the driver. In an exemplary embodiment, the driver device 106 may be a vehicle head unit. In another exemplary embodiment, the driver device 106 may be a communication device, such as a smartphone, a personal digital assistant (PDA), a tablet, or any other portable communication device, that is placed in the vehicle.

The database server 108 is a data management and storage server that manages and stores passenger information of passengers, driver information of drivers, and vehicle information of vehicles. The database server 108 includes a processor (not shown) and a memory (not shown) for managing and storing the passenger, driver, and vehicle information. For example, the passenger information may include a passenger name, a passenger contact number, a passenger rating, or other passenger-related information of the passenger. The driver information may include a driver name, a driver contact number, a driver rating, or other driver-related information of the driver. The vehicle information may include a vehicle type, a vehicle capacity, a vehicle registration number, or other vehicle-related information of the vehicle.

Further, in an embodiment, the processor manages historical booking and demand data of each passenger, and stores in the memory. For example, the historical booking and demand data of each passenger includes historical travel requests by each passenger, historical booking cancellations of each passenger, or historical feedback of each passenger. The historical booking and demand data of each passenger further includes historical pick-up locations, a historical pick-up time associated with each historical pick-up location, and historical drop-off locations associated with each historical pick-up location. Further, in an embodiment, the database server 108 may receive a query from the application server 102 over the communication network 110 to retrieve the stored information of the passengers, the drivers, or the vehicles associated with the drivers. The database server 108, in response to the received query from the application server 102, retrieves and transmits the requested information to the application server 102 over the communication network 110. Examples of the database server 108 include, but are not limited to, a personal computer, a laptop, or a network of computer systems.

In operation, the application server 102 extracts the historical booking and demand data of the passengers from the database server 108. Further, the application server 102 retrieves the location information of each passenger from the extracted historical booking and demand data. The location information includes at least one of the pick-up or drop-off locations of each passenger. The pick-up or drop-off locations are related to historical booking requests (e.g., confirmed or canceled booking requests) of the passengers. Further, in an embodiment, the application server 102 clusters the location information to obtain a set of location clusters. The set of location clusters indicates locations of interests traveled by the passengers, for example, a home place, a work place, a transit place, a commercial place, a historical place, an event-related place, an unknown place, or the like. In an embodiment, the application server 102 clusters the location information by means of a density-based clustering algorithm to obtain the set of location clusters. The density-based clustering algorithm, for example, a density-based spatial clustering of applications with noise (DBSCAN) algorithm is a data clustering algorithm that identifies a set of location points from the location information that are in high density regions, and clusters such set of location points as the set of location clusters. Other location points from the location information may be identified as outlier location points associated with low density regions and may not be further used for identifying the location types.

Further, in an embodiment, the application server 102 generates the set of features for each location cluster of the set of location clusters. The set of features for each location cluster is generated based on the extracted historical booking and demand data of each location cluster. In an embodiment, the set of features for a location cluster includes a set of travel-time-based features and a set of location-type-based features. The set of travel-time-based features includes a set of demand-based features and a set of booking-based features.

In an embodiment, the set of demand-based features includes a first weekday demand feature associated with a first time duration. For example, the first weekday demand feature for the location cluster may indicate weekday morning demands of the passengers for the vehicles from the location cluster i.e., a fraction of weekday demands for the vehicles from the location cluster between 7 AM to 12 PM. Here, 7 AM to 12 PM is the first time duration. The set of demand-based features further includes a second weekday demand feature associated with a second time duration. For example, the second weekday demand feature for the location cluster may indicate weekday afternoon demands of the passenger for the vehicles from the location cluster i.e., a fraction of weekday demands for the vehicles from the location cluster between 12 PM to 5 PM. Here, 12 PM to 5 PM is the second time duration. The set of demand-based features further includes a third weekday demand feature associated with a third time duration. For example, the third weekday demand feature for the location cluster may indicate weekday evening demands of the passengers for the vehicles from the location cluster i.e., a fraction of weekday demands for the vehicles from the location cluster between 5 PM to 10 PM. Here, 5 PM to 10 PM is the third time duration. The set of demand-based features further includes a fourth weekday demand feature associated with a fourth time duration. For example, the fourth weekday demand feature for the location cluster may indicate weekday night demands of the passengers for the vehicles from the location cluster i.e., a fraction of weekday demands for the vehicles from the location cluster between 10 PM to 7 AM. Here, 10 PM to 7 AM is the fourth time duration. In an embodiment, the first, second, third, and fourth time durations may be associated with the weekday (e.g., “Monday”, “Tuesday”, “Wednesday”, “Thursday” or “Friday”) that are different from each other. The set of demand-based features further includes a weekend demand feature. For example, the weekend demand feature for the location cluster may indicate weekend demands of the passengers for the vehicles from the location cluster i.e., a fraction of weekend demands for the vehicles from the location cluster.

In an embodiment, the set of booking-based features includes a first weekday pick-up or drop-off feature associated with the first time duration. For example, the first weekday pick-up feature may indicate the location cluster as the pick-up location of the passengers during the weekday i.e., a fraction of the first time period for which the location cluster was the pick-up location of the passengers during the weekday. Similarly, the first weekday drop-off feature may indicate the location cluster as the drop-off location of the passengers during the weekday i.e., a fraction of the first time period for which the location cluster was the drop-off location of the passengers during the weekday. The set of booking-based features further includes a second weekday pick-up or drop-off feature associated with the second time duration. For example, the second weekday pick-up feature may indicate the location cluster as the pick-up location of the passengers during the weekday i.e., a fraction of the second time period for which the location cluster was the pick-up location of the passengers during the weekday. Similarly, the second weekday drop-off feature may indicate the location cluster as the drop-off location of the passengers during the weekday i.e., a fraction of the second time period for which the location cluster was the drop-off location of the passengers during the weekday.

The set of booking-based features further includes a third weekday pick-up or drop-off feature associated with the third time duration. For example, the third weekday pick-up feature may indicate the location cluster as the pick-up location of the passengers during the weekday i.e., a fraction of the third time period for which the location cluster was the pick-up location of the passengers during the weekday. Similarly, the third weekday drop-off feature may indicate the location cluster as the drop-off location of the passengers during the weekday i.e., a fraction of the third time period for which the location cluster was the drop-off location of the passengers during the weekday. The set of booking-based features further includes a fourth weekday pick-up or drop-off feature associated with the fourth time duration. For example, the fourth weekday pick-up feature may indicate the location cluster as the pick-up location of the passengers during the weekday i.e., a fraction of the fourth time period for which the location cluster was the pick-up location of the passengers during the weekday. Similarly, the fourth weekday drop-off feature may indicate the location cluster as the drop-off location of the passengers during the weekday i.e., a fraction of the fourth time period for which the location cluster was the drop-off location of the passengers during the weekday. The set of booking-based features further includes a weekend pick-up or drop-off feature. For example, the weekend pick-up feature may indicate the location cluster as the pick-up location of the passengers during the weekend i.e., a fraction of the weekend for which the location cluster was the pick-up location of the passengers during the weekend. Similarly, the weekend drop-off feature may indicate the location cluster as the drop-off location of the passengers during the weekend i.e., a fraction of the weekend for which the location cluster was the drop-off location of the passengers during the weekend.

In an embodiment, the set of location-type-based features includes the set of demand-based features and the set of booking-based features of the set of travel-time-based features. The set of location-type-based features further includes an average stay time of each passenger in the location cluster. A stay time of each passenger indicates a time period for which each passenger may have stayed in the location cluster. The average stay time of each passenger indicates an average of stay times of each passenger in the location cluster. The set of location-type-based features further includes a percentage of return demands from the location cluster by each passenger. A return demand from the location cluster indicates a booking request for the ride such that the location cluster is a pick-up location. The percentage of return demands indicates a fraction of the passengers who have initiated booking requests for their rides such that the location cluster is their pick-up locations. For example, out of 100 passengers who were dropped to the location cluster based on their ride requests, if 75 passengers have requested for return demands from the location cluster as their pick-up location, the fraction of return demands is 0.75 (i.e., 75 divided by 100) and the percentage of return demands is 75%.

Further, in an embodiment, the application server 102 trains the classifier based on the generated set of features of the set of location clusters. The classifier is trained by means of a classification technique to identify a location type of each location cluster. The classification technique is a systematic approach to build classification models based on the generated set of features. For example, decision tree classifiers, rule-based classifiers, neural networks, support vector machines, naive Bayes classifiers, or the like are different classification techniques that may adopt a learning algorithm based on the generated set of features to identify the location type of each location cluster. In an exemplary embodiment, a tree-based model, such as a decision tree classifier, may be generated based on the set of travel-time-based features, the set of location-type-based features, or a combination thereof. The tree-based model may further be used for classifying the location information of each passenger into at least one of the home location, the work location, the commercial location, the transit location, the unknown location, or the like.

Further, in an embodiment, the application server 102 receives location information of the passenger from the passenger device 104 over the communication network 110. The application server 102 generates a set of features based on at least one of a pick-up or a drop-off location associated with the received location information of the passenger. The set of features includes at least one of the set of travel-time-based features or the set of location-type-based features, as described above. The generated set of features associated with the passenger is provided as an input to the trained classifier. The trained classifier identifies the location type of the location information of the passenger. The classification of the location information of the passenger for identifying the location type has been described in detail in conjunction with FIGS. 2A and 2B.

Referring now to FIGS. 2A and 2B, an exemplary sequence diagram 200 for classifying the location information of the passenger by means of the tree-based model is shown, in accordance with an embodiment of the present invention.

At 202, the location information of the passenger may be classified into one of the location types, for example, the home location or the work location. In an embodiment, based on the extracted historical booking and demand data of the passenger, the application server 102 determines a probability of the location information being the home location or the work location of the passenger. For example, as shown, the probability that the location information is the home location is 0.74, and the probability that the location information is the work location is 0.26. Since the probability of the location information being the home location (0.74) is greater than the probability of the location information being the work location (0.26), the location information of the passenger is classified as the home location.

At 204, the application server 102 checks whether a weekday morning pick-up (wdmp) of the passenger is greater than or equal to a first defined threshold value. The weekday morning pick-up (wdmp) is the fraction of the morning time for which the location information was the pick-up location of the passenger during the weekday. If the weekday morning pick-up (wdmp) is greater than or equal to the first defined threshold value (e.g., 0.015), the control flows to 206. However, if the weekday morning pick-up (wdmp) is less than the first defined threshold value (e.g., 0.015), the control flows to 220.

At 206, the location information may further be classified as the home location. In an embodiment, based on the extracted historical booking and demand data of the passenger, the application server 102 determines the probability of the location information being the home location or the work location of the passenger. For example, as shown, the probability that the location information is the home location is 0.93, and the probability that the location information is the work location is 0.07. Thus, due to higher probability, the location information of the passenger may be classified as the home location. Further, an overall probability that the location information is the home location is determined as 0.69 (i.e., 0.93*0.74=0.6882˜0.69 i.e., 69%).

At 208, the application server 102 checks whether a weekday morning drop-off (wdmdr) of the passenger is less than a second defined threshold value. The weekday morning drop-off (wdmdr) is the fraction of the morning time for which the location information was the drop-off location of the passenger during the weekday. If the weekday morning drop-off (wdmdr) is less than the second defined threshold value (e.g., 0.12), the control flows to 210. However, if the weekday morning drop-off (wdmdr) is greater than or equal to the second defined threshold value (e.g., 0.12), the control flows to 212.

At 210, the location information may further be classified as the home location. In an embodiment, based on the extracted historical booking and demand data of the passenger, the application server 102 determines the probability of the location information being the home location or the work location of the passenger. For example, as shown, the probability that the location information is the home location is 0.95, and the probability that the location information is the work location is 0.05. Thus, due to higher probability, the location information of the passenger may be classified as the home location. Further, the overall probability that the location information is the home location is determined as 0.66 (i.e., 0.95*0.93*0.74=0.653˜0.66 i.e., 66%).

At 212, the location information may further be classified as the work location. In an embodiment, based on the extracted historical booking and demand data of the passenger, the application server 102 determines the probability of the location information being the home location or the work location of the passenger. For example, as shown, the probability that the location information is the home location is 0.32, and the probability that the location information is the work location is 0.68. Thus, due to higher probability, the location information of the passenger may be classified as the work location. Further, an overall probability that the location information is the work location is determined as 0.03 (i.e., 0.74*0.07*0.68=0.03 i.e., 3%).

At 214, the application server 102 checks whether a percentage demand (demp) of the passenger is greater than or equal to a third defined threshold value. The percentage demand (demp) is the fraction of demands with respect to the total demands generated by the passenger from the location. If the percentage demand (demp) is greater than or equal to the third defined threshold value (e.g., 0.47), the control flows to 216. However, if the percentage demand (demp) is less than the third defined threshold value (e.g., 0.47), the control flows to 218.

At 216, the location information may further be classified as the home location. In an embodiment, based on the extracted historical booking and demand data of the passenger, the application server 102 determines the probability of the location information being the home location or the work location of the passenger. For example, as shown, the probability that the location information is the home location is 0.93, and the probability that the location information is the work location is 0.07. Thus, due to higher probability, the location information of the passenger may be classified as the home location. Further, the overall probability that the location information is the home location is determined as 0.02 (i.e., 0.74*0.07*0.32*0.93=0.015˜0.02 i.e., 2%).

At 218, the location information may further be classified as the work location. In an embodiment, based on the extracted historical booking and demand data of the passenger, the application server 102 determines the probability of the location information being the home location or the work location of the passenger. For example, as shown, the probability that the location information is the home location is 0.12, and the probability that the location information is the work location is 0.88. Thus, due to higher probability, the location information of the passenger may be classified as the work location. Further, the overall probability that the location information is the work location is determined as 0.03 (i.e., 0.74*0.07*0.68*0.88=0.0309˜0.03 i.e., 3%).

At 220, the location information may further be classified as the work location. In an embodiment, based on the extracted historical booking and demand data of the passenger, the application server 102 determines the probability of the location information being the home location or the work location of the passenger. For example, as shown, the probability that the location information is the home location is 0.31, and the probability that the location information is the work location is 0.69. Thus, due to higher probability, the location information of the passenger may be classified as the work location. Further, the overall probability that the location information is the work location is determined as 0.18 (i.e., 0.26*0.69=0.1794˜0.18 i.e., 18%).

At 222, the application server 102 checks whether the weekday morning drop-off (wdmdr) of the passenger is less than a fourth defined threshold value. The weekday morning drop-off (wdmdr) is the fraction of the morning time for which the location information was the drop-off location of the passenger during the weekday. If the weekday morning drop-off (wdmdr) is less than the fourth defined threshold value (e.g., 0.045), the control flows to 224. However, if the weekday morning drop-off (wdmdr) is greater than or equal to the fourth defined threshold value (e.g., 0.045), the control flows to 238.

At 224, the location information may further be classified as the home location. In an embodiment, based on the extracted historical booking and demand data of the passenger, the application server 102 determines the probability of the location information being the home location or the work location of the passenger. For example, as shown, the probability that the location information is the home location is 0.59, and the probability that the location information is the work location is 0.41. Thus, due to higher probability, the location information of the passenger may be classified as the home location. Further, the overall probability that the location information is the home location is determined as 0.05 (i.e., 0.26*0.31*0.59=0.047˜0.05 i.e., 5%).

At 226, the application server 102 performs a check to determine whether a weekend demand (wed) of the passenger is greater than or equal to a fifth defined threshold value. The weekend demand (wed) is the fraction of weekend demands from the location of the passenger. If the weekend demand (wed) is greater than or equal to the fifth defined threshold value (e.g., 0.015), the control flows to 228. However, if the weekend demand (wed) is less than the fifth defined threshold value (e.g., 0.015), the control flows to 236.

At 228, the location information may further be classified as the home location. In an embodiment, based on the extracted historical booking and demand data of the passenger, the application server 102 determines the probability of the location information being the home location or the work location of the passenger. For example, as shown, the probability that the location information is the home location is 0.72, and the probability that the location information is the work location is 0.28. Thus, due to higher probability, the location information of the passenger may be classified as the home location. Further, the overall probability that the location information is the home location is determined as 0.03 (i.e., 0.26*0.31*0.59*0.72=0.0342˜0.03 i.e., 3%).

At 230, the application server 102 performs a check to determine whether a weekday evening pick-up (wdep) of the passenger is less than a sixth defined threshold value. The weekday evening pick-up (wdep) is the fraction of the evening time for which the location information was the pick-up location of the passenger during the weekday. If the weekday evening pick-up (wdep) is less than the sixth defined threshold value (e.g., 0.4), the control flows to 232.

However, if the weekday evening pick-up (wdep) is greater than or equal to the sixth defined threshold value (e.g., 0.4), the control flows to 234.

At 232, the location information may further be classified as the home location. In an embodiment, based on the extracted historical booking and demand data of the passenger, the application server 102 determines the probability of the location information being the home location or the work location of the passenger. For example, as shown, the probability that the location information is the home location is 0.75, and the probability that the location information is the work location is 0.25. Thus, due to higher probability, the location information of the passenger may be classified as the home location. Further, the overall probability that the location information is the home location is determined as 0.03 (i.e., 0.26*0.31*0.59*0.72*0.75=0.0256˜0.03 i.e., 3%).

At 234, the location information may further be classified as the work location. In an embodiment, based on the extracted historical booking and demand data of the passenger, the application server 102 determines the probability of the location information being the home location or the work location of the passenger. For example, as shown, the probability that the location information is the home location is 0, and the probability that the location information is the work location is 1. Thus, the overall probability that the location information is the work location is determined as 0.02 (i.e., 0.26*0.69*0.41*0.28=0.0205˜0.02 i.e., 2%).

At 236, the location information may further be classified as the work location. In an embodiment, based on the extracted historical booking and demand data of the passenger, the application server 102 determines the probability of the location information being the home location or the work location of the passenger. For example, as shown, the probability that the location information is the home location is 0.23, and the probability that the location information is the work location is 0.77. Thus, due to higher probability, the location information of the passenger may be classified as the work location. Further, the overall probability that the location information is the work location is determined as 0.06 (i.e., 0.26*0.69*0.41*0.77=0.0566˜0.06 i.e., 6%).

At 238, the location information may further be classified as the work location. In an embodiment, based on the extracted historical booking and demand data of the passenger, the application server 102 determines the probability of the location information being the home location or the work location of the passenger. For example, as shown, the probability that the location information is the home location is 0.09, and the probability that the location information is the work location is 0.91. Thus, due to higher probability, the location information of the passenger may be classified as the work location. Further, the overall probability that the location information is the work location is determined as 0.16 (i.e., 0.26*0.69*0.91=0.1632˜0.16 i.e., 16%).

The location type of the location information of the passenger may be identified based on at least the highest probability among the overall probabilities (as shown at 210, 216, 218, 232, 234, 236, and 238 of FIG. 2B). For example, the highest probability is 0.66 (i.e., 66%), and therefore, the location type of the location information of the passenger is identified as the home location. In another embodiment, the application server 102 may perform one or more algebraic or statistical operations, or a combination thereof, based on the overall probabilities (as shown at 210, 216, 218, 232, 234, 236, and 238 of FIG. 2B), and thereafter, may take a decision to determine the location type of the location information of the passenger.

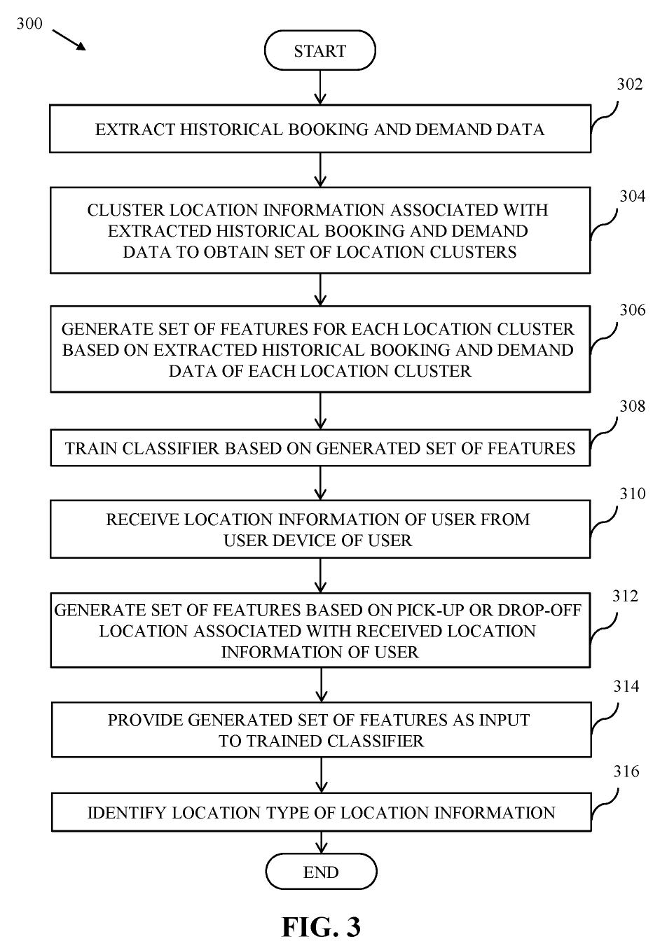

Referring now to FIG. 3, a flow chart 300 that illustrates a method for identifying the location types of the passengers is shown, in accordance with an embodiment of the present invention.

At step 302, the application server 102 extracts the historical booking and demand data of the passengers from the database server 108 over the communication network 110. The historical booking and demand data of each passenger includes the historical travel requests or the historical booking cancellations by each passenger. The historical booking and demand data further includes the historical pick-up locations of each passenger, the historical pick-up time associated with each of the historical pick-up locations, and the historical drop-off locations associated with each of the historical pick-up locations.

At step 304, the location information associated with the extracted historical booking and demand data is clustered. The application server 102 clusters the location information to obtain the set of location clusters. The location information is clustered by means of the density-based clustering algorithm to obtain the set of location clusters. In one embodiment, each location cluster may indicate a location point, for example, a commercial place or a work place, of a geographical area. In another embodiment, each location cluster may include the location point of the geographical area along with a defined radial distance along the location point. For example, if the location point is a commercial place (e.g., a shopping mall), then the location cluster may include the commercial place along with the defined radial distance (e.g., 300 meters) around the commercial place. Such location cluster may be used to identify a commercial area, a residential area, or a workplace area.

At step 306, the application server 102 generates the set of features for each location cluster of the set of location clusters based on the extracted historical booking and demand data of each location cluster. In an embodiment, the set of features includes the set of travel-time-based features and the set of location-type-based features. The set of travel-time-based features includes the demand-based features and the booking-based features. The demand-based features include one or more features such as the first weekday demand feature, the second weekday demand feature, the third weekday demand feature, the fourth weekday demand feature, and the weekend demand feature. The booking-based features includes one or more features such as the first weekday pick-up or drop-off feature, the second weekday pick-up or drop-off feature, the third weekday pick-up or drop-off feature, the fourth weekday pick-up or drop-off feature, and the weekend pick-up or drop-off feature.

Further, in an embodiment, the set of location-type-based features includes the set of demand-based features and the set of booking-based features of the set of travel-time-based features. The set of location-type-based features further includes the average stay time of each passenger in one or more location clusters and the percentage of return demands from the one or more location clusters by each passenger.

At step 308, the application server 102 trains the classifier based on the generated set of features to identify the location types of each location cluster. The classifier may be one of a decision tree classifier, a rule-based classifier, a neural network, a support vector machine, a naive Bayes classifier, or the like. In an exemplary embodiment, the set of travel-time-based features and the set of location-type-based features may be combined to generate the tree-based model (i.e., the decision tree classifier) for classifying the location information of each passenger.

At step 310, the application server 102 receives the location information of the passenger from the passenger device 104 over the communication network 110. At step 312, the application server 102 generates the set of features based on at least one of the pick-up or drop-off location associated with the received location information of the passenger. The set of features includes at least one of the set of travel-time-based features or the set of location-type-based features, as described above. At step 314, the generated set of features associated with the passenger is provided as the input to the trained classifier. At step 316, the trained classifier identifies the location type of the location information of the passenger. FIGS. 2A and 2B, as described above, illustrates an exemplary sequence diagram for classifying the location information of the passenger by means of the tree-based model.

Based on the identified location types of the passenger, personalized experiences may be provided to the passenger. For example, the personalized experiences may include ensuring the availability of one or more vehicles at or near the identified location types at the time of pick-up from the identified location types. Further, future demands may be predicted for the passenger. For example, based on the identified location type of the passenger from where the passenger may take the vehicle for the ride (e.g., home to office, home to shopping, or the like), the cab service provider may identify the preferences of the passenger for various locations, and hence will ensure the availability of the one or more vehicles for the passenger from the identified location by making more vehicles available near the identified location. Further, a travel related intent of the passenger may be predicted based on the identified location. Such travel related intent may be used by the cab service provider to prioritize the future demands requested by the passenger.

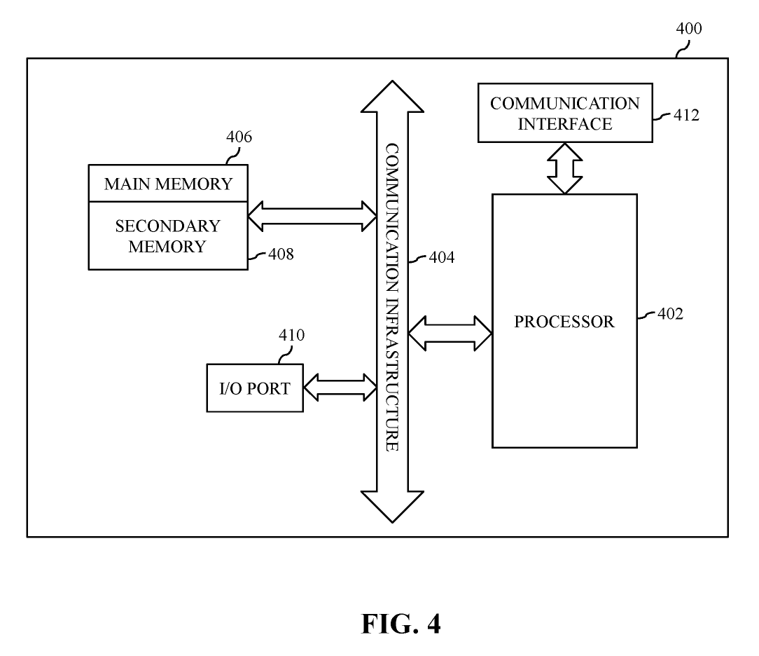

Referring now to FIG. 4, a block diagram that illustrates a computer system 400 for identifying location types of passengers is shown, in accordance with an embodiment of the present invention. An embodiment of the present invention, or portions thereof, may be implemented as computer readable code on the computer system 400. In one example, the application server 102 and the database server 108 of FIG. 1 may be implemented in the computer system 400 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIG. 3.

The computer system 400 includes a processor 402 that may be a special purpose or a general-purpose processing device. The processor 402 may be a single processor, multiple processors, or combinations thereof. The processor 402 may have one or more processor “cores.” Further, the processor 402 may be connected to a communication infrastructure 404, such as a bus, a bridge, a message queue, the communication network 110, multi-core message-passing scheme, and the like. The computer system 400 further includes a main memory 406 and a secondary memory 408. Examples of the main memory 406 may include RAM, ROM, and the like. The secondary memory 408 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 400 further includes an input/output (I/O) port 410 and a communication interface 412. The I/O port 410 includes various input and output devices that are configured to communicate with the processor 402. Examples of the input devices may include a keyboard, a mouse, a joystick, a touchscreen, a microphone, and the like. Examples of the output devices may include a display screen, a speaker, headphones, and the like. The communication interface 412 may be configured to allow data to be transferred between the computer system 400 and various devices that are communicatively coupled to the computer system 400. Examples of the communication interface 412 may include a modem, a network interface, i.e., an Ethernet card, a communications port, and the like. Data transferred via the communication interface 412 may be signals, such as electronic, electromagnetic, optical, or other signals as will be apparent to a person skilled in the art. The signals may travel via a communications channel, such as the communication network 110 which may be configured to transmit the signals to the various devices that are communicatively coupled to the computer system 400. Examples of the communication channel may include, but are not limited to, cable, fiber optics, a phone line, a cellular phone link, a radio frequency link, a wireless link, and the like.

Computer program medium and computer usable medium may refer to memories, such as the main memory 406 and the secondary memory 408, which may be a semiconductor memory such as dynamic RAMs. These computer program mediums may provide data that enables the computer system 400 to implement the methods illustrated in FIG. 3. In an embodiment, the present invention is implemented using a computer implemented application. The computer implemented application may be stored in a computer program product and loaded into the computer system 400 using the removable storage drive or the hard disc drive in the secondary memory 408, the I/O port 410, or the communication interface 412.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 402, and a memory, such as the main memory 406 and the secondary memory 408, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present invention provide, among other features, systems and methods for identifying the location types of the passengers for providing the personalized experience with respect to their future rides. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

What is claimed is:

1. A method for identifying location types of each passenger in a transportation network, the method comprising:
extracting historical booking and demand data of passengers from a database server over a communication network;
clustering location information associated with the extracted historical booking and demand data to obtain a set of location clusters;
generating a set of features for each location cluster of the set of location clusters based on the extracted historical booking and demand data of each location cluster;
training a classifier based on the generated set of features of the set of location clusters to identify a type of each location cluster;
receiving location information of a passenger from a passenger device of the passenger over the communication network;
generating a set of features based on a pick-up or drop-off location associated with the received location information of the passenger; and
providing the generated set of features associated with the passenger as an input to the trained classifier, wherein the trained classifier identifies a location type of the location information of the passenger.

2. The method of claim 1, wherein the location information associated with the extracted historical booking and demand data is clustered by means of a density-based clustering algorithm to obtain the set of location clusters.

3. The method of claim 1, wherein the set of features includes a set of travel-time-based features and a set of location-type-based features.

4. The method of claim 3, wherein the set of travel-time-based features includes demand-based features and booking-based features.

5. The method of claim 4, wherein the demand-based features comprise a first weekday demand feature associated with a first time duration, a second weekday demand feature associated with a second time duration, a third weekday demand feature associated with a third time duration, a fourth weekday demand feature associated with a fourth time duration, and a weekend demand feature, wherein the first, second, third, and fourth time durations of each weekday are different from each other.

6. The method of claim 4, wherein the booking-based features comprises a first weekday pick-up or drop-off feature associated with a first time duration, a second weekday pick-up or drop-off feature associated with a second time duration, a third weekday pick-up or drop-off feature associated with a third time duration, a fourth weekday pick-up or drop-off feature associated with a fourth time duration, and a weekend pick-up or drop-off feature, wherein the first, second, third, and fourth time durations of each weekday are different from each other.

7. The method of claim 3, wherein the set of location-type-based features includes demand-based features and booking-based features of the set of travel-time-based features.

8. The method of claim 7, wherein the set of location-type-based features further includes an average stay time of each passenger in a location and a percentage of return demands from the location by each passenger.

9. The method of claim 1, further comprising combining a set of travel-time-based features and a set of location-type-based features of the set of features to generate a tree-based model for classifying the location information of each passenger into at least one of a home location, a work location, a commercial location, a transit location, or an unknown location.

10. A system for identifying location types of each passenger in a transportation network, the system comprising:
circuitry configured to:
extract historical booking and demand data of passengers from a database server over a communication network;
cluster location information associated with the extracted historical booking and demand data to obtain a set of location clusters;
generate a set of features for each location cluster of the set of location clusters based on the extracted historical booking and demand data of each location cluster;
train a classifier based on the generated set of features of the set of location clusters to identify a type of each location cluster;
receive location information of a passenger from a passenger device of the passenger over the communication network;
generate a set of features based on a pick-up or drop-off location associated with the received location information of the passenger; and
provide the generated set of features associated with the passenger as an input to the trained classifier, wherein the trained classifier identifies a location type of the location information of the passenger.

11. The system of claim 10, wherein the circuitry is further configured to cluster the location information associated with the extracted historical booking and demand data by means of a density-based clustering algorithm to obtain the set of location clusters.

12. The system of claim 10, wherein the set of features includes a set of travel-time-based features and a set of location-type-based features.

13. The system of claim 12, wherein the set of travel-time-based features includes demand-based features and booking-based features.

14. The system of claim 13, wherein the demand-based features comprise a first weekday demand feature associated with a first time duration, a second weekday demand feature associated with a second time duration, a third weekday demand feature associated with a third time duration, a fourth weekday demand feature associated with a fourth time duration, and a weekend demand feature, wherein the first, second, third, and fourth time durations of each weekday are different from each other.

15. The system of claim 13, wherein the booking-based features comprise a first weekday pick-up or drop-off feature associated with a first time duration, a second weekday pick-up or drop-off feature associated with a second time duration, a third weekday pick-up or drop-off feature associated with a third time duration, a fourth weekday pick-up or drop-off feature associated with a fourth time duration, and a weekend pick-up or drop-off feature, wherein the first, second, third, and fourth time durations of each weekday are different from each other.

16. The system of claim 12, wherein the set of location-type-based features includes demand-based features and booking-based features of the set of travel-time-based features.

17. The system of claim 16, wherein the set of location-type-based features further includes an average stay time of each passenger in a location and a percentage of return demands from the location by each passenger.

18. The system of claim 10, wherein the circuitry is further configured to combine a set of travel-time-based features and a set of location-type-based features of the set of features to generate a tree-based model for classifying the location information of each passenger into at least one of a home location, a work location, a commercial location, a transit location, or an unknown location.
